(19) United States
(12) Patent Application Publication
(10) Pub. No.: US 2024/0098519 A1
(43) Pub. Date: Mar. 21, 2024

(54) SIDELINK RESOURCE ALLOCATION

(71) Applicant: QUALCOMM Incorporated, San Diego, CA (US)

(72) Inventors: Sourjya DUTTA, San Diego, CA (US); Gabi SARKIS, San Diego, CA (US); Tien Viet NGUYEN, Bridgewater, NJ (US); Shuanshuan WU, San Diego, CA (US); Kapil GULATI, Belle Mead, NJ (US)

(21) Appl. No.: 17/933,400

(22) Filed: Sep. 19, 2022

(51) Int. Cl. H04W 16/28; H04W 72/02; H04W 72/04

(52) U.S. Cl. CPC H04W 16/28; H04W 72/02; H04W 72/046

(57) ABSTRACT

Various aspects of the present disclosure generally relate to wireless communication. In some aspects, a transmitter user equipment (UE) may transmit, to a receiver UE, a request for sensing information that includes an indication of one or more transmit beam directions. The UE may receive, from the receiver UE based at least in part on the indication of the one or more transmit beam directions, sensing information associated with a beam of a plurality of beams configured for communications between the transmitter UE and the receiver UE. Numerous other aspects are described.

### FIELD OF THE DISCLOSURE

Aspects of the present disclosure generally relate to wireless communication and to techniques and apparatuses for sidelink resource allocation.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Tenn Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a transmitter user equipment (UE). The method may include transmitting, to a receiver UE, a request for sensing information that includes an indication of one or more transmit beam directions. The method may include receiving, from the receiver UE based at least in part on the indication of the one or more transmit beam directions, sensing information associated with a beam of a plurality of beams configured for communications between the transmitter UE and the receiver UE.

Some aspects described herein relate to a method of wireless communication performed by a receiver UE. The method may include receiving, from a transmitter UE, a request for sensing information that includes an indication of one or more transmit beam directions. The method may include performing a sensing operation associated with a select beam, of a plurality of beams configured for communications between the transmitter UE and the receiver UE, based at least in part on the indication of the one or more transmit beam directions. The method may include transmitting, to the transmitter UE, an indication of the sensing information associated with the select beam.

Some aspects described herein relate to an apparatus for wireless communication performed by a UE. The apparatus may include a memory and one or more processors, coupled to the memory. The one or more processors may be configured to transmit, to a receiver UE, a request for sensing information that includes an indication of one or more transmit beam directions. The one or more processors may be configured to receive, from the receiver UE based at least in part on the indication of the one or more transmit beam directions, sensing information associated with a beam of a plurality of beams configured for communications between the transmitter UE and the receiver UE.

Some aspects described herein relate to an apparatus for wireless communication performed by a UE. The apparatus may include a memory and one or more processors, coupled to the memory. The one or more processors may be configured to receive, from a transmitter UE, a request for sensing information that includes an indication of one or more transmit beam directions. The one or more processors may be configured to perform a sensing operation associated with a select beam, of a plurality of beams configured for communications between the transmitter UE and the receiver UE, based at least in part on the indication of the one or more transmit beam directions. The one or more processors may be configured to transmit, to the transmitter UE, an indication of the sensing information associated with the select beam.

Some aspects described herein relate to a non-transitory computer-readable medium that stores a set of instructions for wireless communication by a transmitter UE. The set of instructions, when executed by one or more processors of the UE, may cause the UE to transmit, to a receiver UE, a request for sensing information that includes an indication of one or more transmit beam directions. The set of instructions, when executed by one or more processors of the UE, may cause the UE to receive, from the receiver UE based at least in part on the indication of the one or more transmit beam directions, sensing information associated with a beam of a plurality of beams configured for communications between the transmitter UE and the receiver UE.

Some aspects described herein relate to a non-transitory computer-readable medium that stores a set of instructions for wireless communication by a receiver UE. The set of instructions, when executed by one or more processors of the UE, may cause the UE to receive, from a transmitter UE, a request for sensing information that includes an indication of one or more transmit beam directions. The set of instructions, when executed by one or more processors of the UE, may cause the UE to perform a sensing operation associated with a select beam, of a plurality of beams configured for communications between the transmitter UE and the receiver UE, based at least in part on the indication of the one or more transmit beam directions. The set of instructions, when executed by one or more processors of the UE, may cause the UE to transmit, to the transmitter UE, an indication of the sensing information associated with the select beam.

Some aspects described herein relate to an apparatus for wireless communication. The apparatus may include means for transmitting, to a receiver UE, a request for sensing information that includes an indication of one or more transmit beam directions. The apparatus may include means for receiving, from the receiver UE based at least in part on the indication of the one or more transmit beam directions, sensing information associated with a beam of a plurality of beams configured for communications between the transmitter UE and the receiver UE.

Some aspects described herein relate to an apparatus for wireless communication. The apparatus may include means for receiving, from a transmitter UE, a request for sensing information that includes an indication of one or more transmit beam directions. The apparatus may include means for performing a sensing operation associated with a select beam, of a plurality of beams configured for communications between the transmitter UE and the receiver UE, based at least in part on the indication of the one or more transmit beam directions. The apparatus may include means for transmitting, to the transmitter UE, an indication of the sensing information associated with the select beam.

Aspects generally include a method, apparatus, system, computer program product, non-transitory computer-readable medium, user equipment, base station, network entity, network node, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating an example of sidelink resource selection, in accordance with the present disclosure.

FIG. 6 is a diagram illustrating an example of transmitter-side sensing and receiver-side sensing for sidelink communications, in accordance with the present disclosure.

FIG. 7 is a diagram illustrating an example of sidelink resource allocation, in accordance with the present disclosure.

FIG. 8 is a diagram illustrating an example of transmitter-side resource selection, in accordance with the present disclosure.

FIG. 9 is a diagram illustrating an example process performed, for example, by a transmitter UE, in accordance with the present disclosure.

FIG. 10 is a diagram illustrating an example process performed, for example, by a receiver UE, in accordance with the present disclosure.

FIG. 11 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

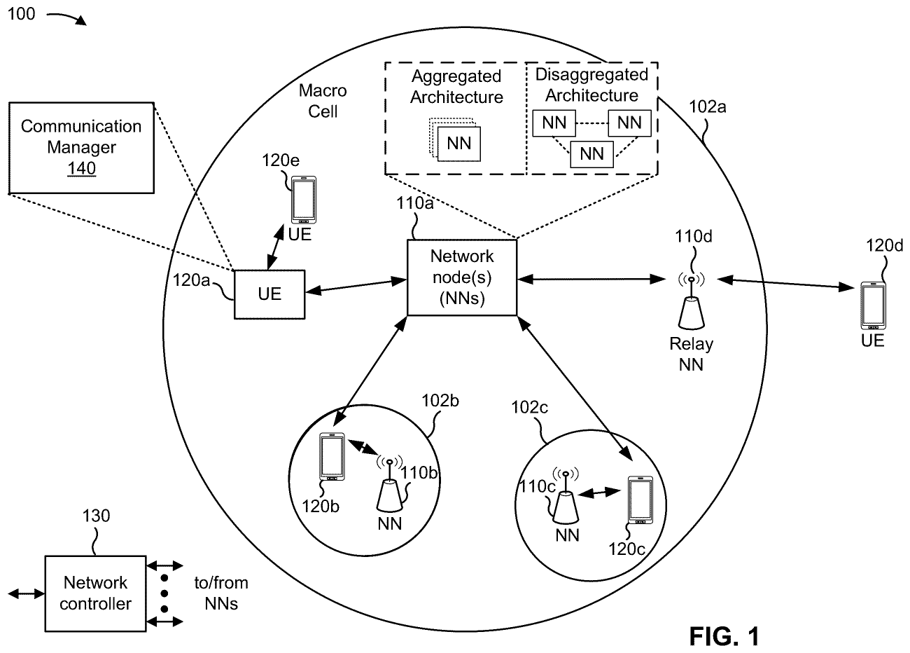

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit, to a receiver UE, a request for sensing information that includes an indication of one or more transmit beam directions; and receive, from the receiver UE based at least in part on the indication of the one or more transmit beam directions, sensing information associated with a beam of a plurality of beams configured for communications between the transmitter UE and the receiver UE. Additionally, or alternatively, the communication manager 140 may perform one or more other operations described herein.

In some aspects, the communication manager 140 may receive, from a transmitter UE, a request for sensing information that includes an indication of one or more transmit beam directions; perform a sensing operation associated with a select beam, of a plurality of beams configured for communications between the transmitter UE and the receiver UE, based at least in part on the indication of the one or more transmit beam directions; and transmit, to the transmitter UE, an indication of the sensing information associated with the select beam. Additionally, or alternatively, the communication manager 140 may perform one or more other operations described herein.

As indicated above, FIG. 1 is provided as an example. Other examples may differ from what is described with regard to FIG. 1.

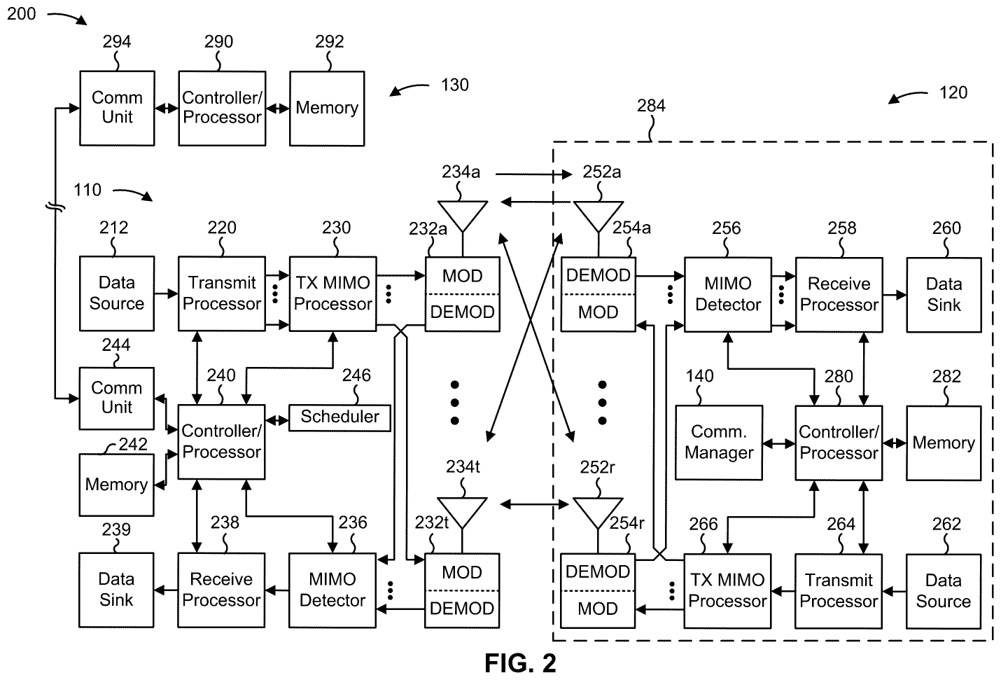

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

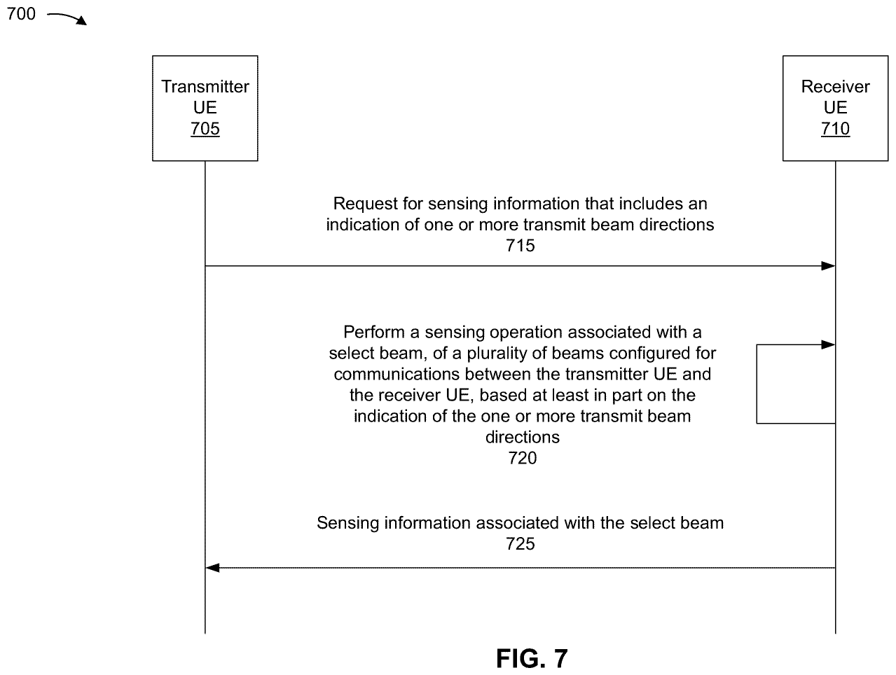

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-11).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-11).

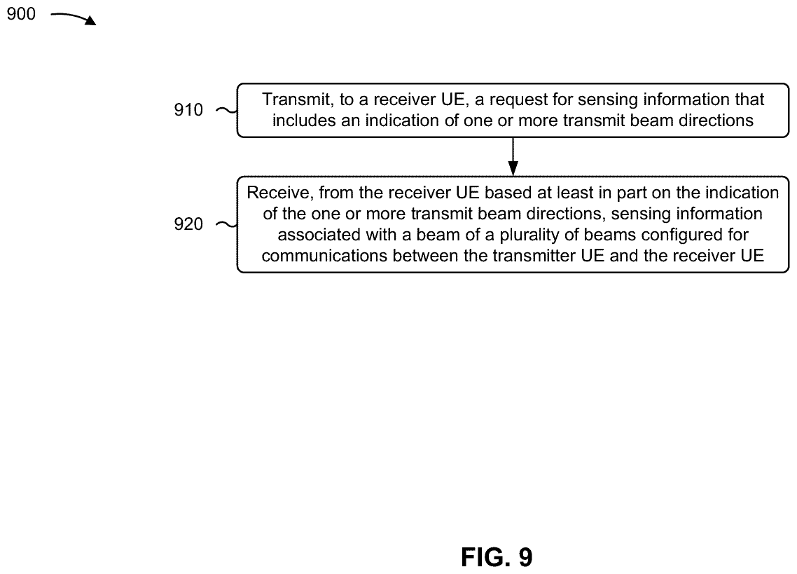

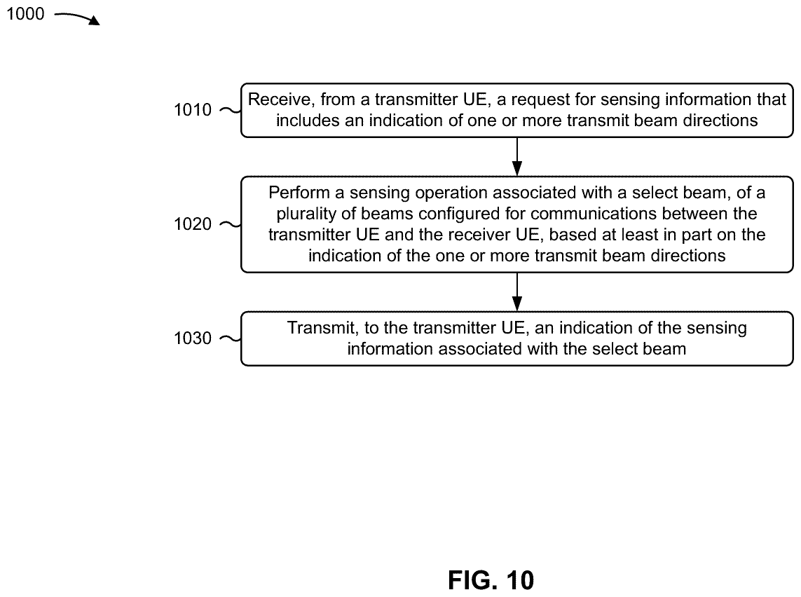

The controller/processor 240 of the network node 110, the controller/processor 280 of the UE 120, and/or any other component(s) of FIG. 2 may perform one or more techniques associated with sidelink resource allocation, as described in more detail elsewhere herein. For example, the controller/processor 240 of the network node 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, a transmitter UE (e.g., the UE 120) includes means for transmitting, to a receiver UE, a request for sensing information that includes an indication of one or more transmit beam directions; and/or means for receiving, from the receiver UE based at least in part on the indication of the one or more transmit beam directions, sensing information associated with a beam of a plurality of beams configured for communications between the transmitter UE and the receiver UE. The means for the transmitter UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a receiver UE (e.g., the UE 120) includes means for receiving, from a transmitter UE, a request for sensing information that includes an indication of one or more transmit beam directions; means for performing a sensing operation associated with a select beam, of a plurality of beams configured for communications between the transmitter UE and the receiver UE, based at least in part on the indication of the one or more transmit beam directions; and/or means for transmitting, to the transmitter UE, an indication of the sensing information associated with the select beam. The means for the receiver UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

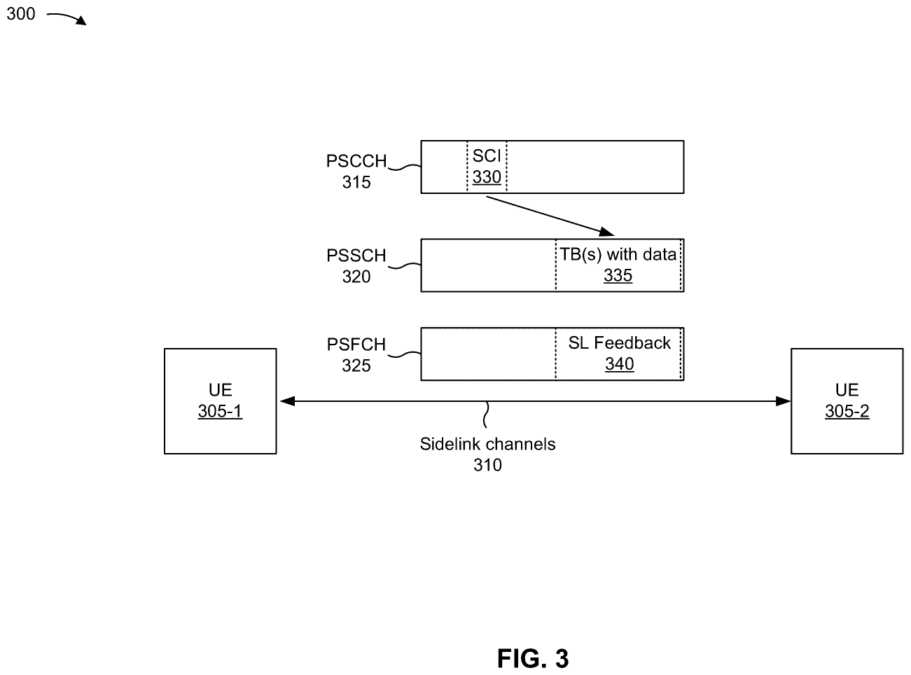

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a network node 110 via an access link or an access channel. The PSSCH 320 may be used to communicate data, similar to a physical downlink shared channel (PDSCH) and/or a physical uplink shared channel (PUSCH) used for cellular communications with a network node 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QoS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 320, such as a HARQ process ID, a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a sidelink transmission mode (e.g., Mode 1) where resource selection and/or scheduling is performed by a network node 110 (e.g., a base station, a CU, or a DU). For example, the UE 305 may receive a grant (e.g., in downlink control information (DCI) or in a radio resource control (RRC) message, such as for configured grants) from the network node 110 (e.g., directly or via one or more network nodes) for sidelink channel access and/or scheduling. In some aspects, a UE 305 may operate using a transmission mode (e.g., Mode 2) where resource selection and/or scheduling is performed by the UE 305 (e.g., rather than a network node 110). In some aspects, the UE 305 may perform resource selection and/or scheduling by sensing channel availability for transmissions. For example, the UE 305 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy ratio (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or an MCS to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As indicated above, FIG. 3 is provided as an example. Other examples may differ from what is described with respect to FIG. 3.

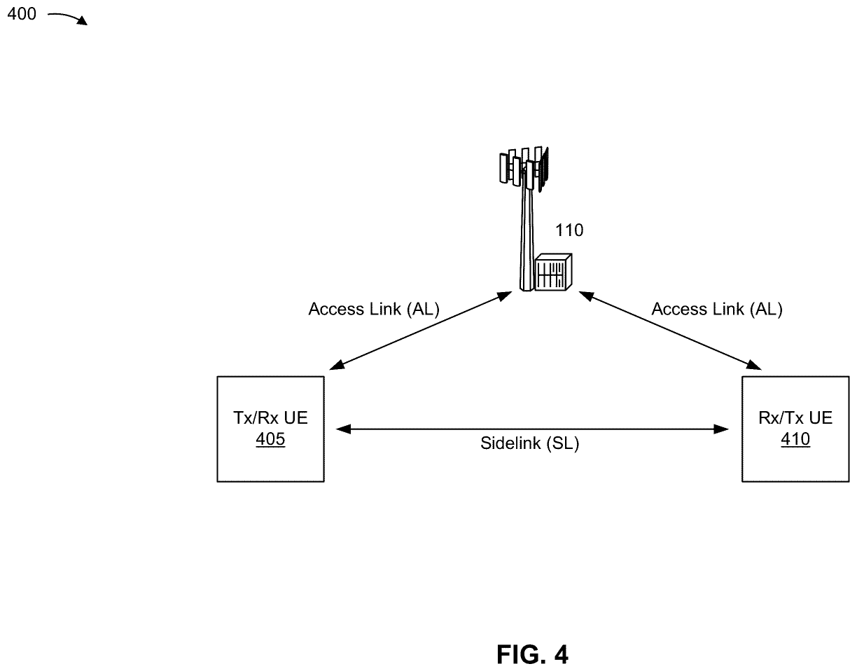

FIG. 4 is a diagram illustrating an example 400 of sidelink communications and access link communications, in accordance with the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a network node 110 may communicate with the Tx/Rx UE 405 (e.g., directly or via one or more network nodes), such as via a first access link. Additionally, or alternatively, in some sidelink modes, the network node 110 may communicate with the Rx/Tx UE 410 (e.g., directly or via one or more network nodes), such as via a first access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a network 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

As indicated above, FIG. 4 is provided as an example. Other examples may differ from what is described with respect to FIG. 4.

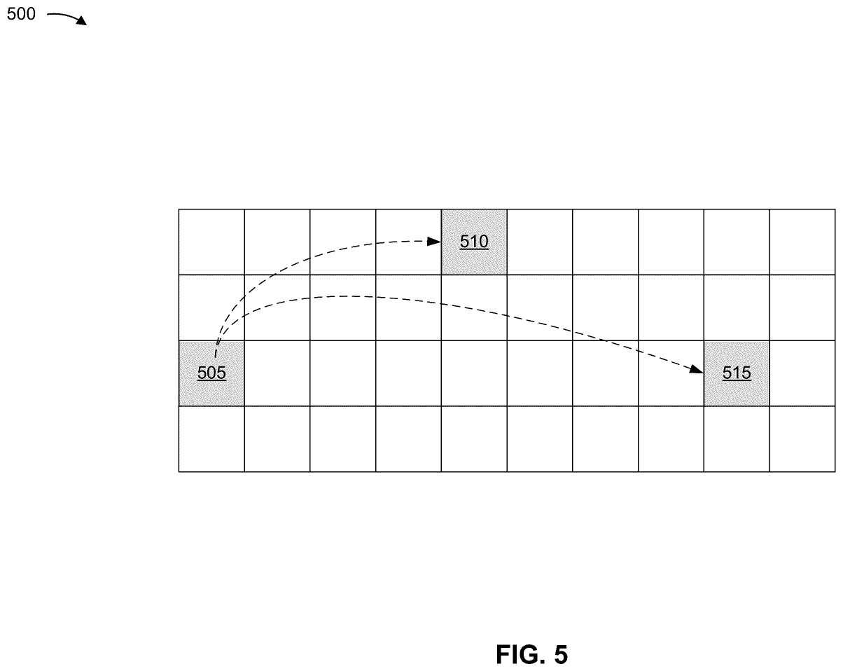

FIG. 5 is a diagram illustrating an example 500 of sidelink resource selection, in accordance with the present disclosure. As described herein, sidelink UEs may reserve one or more resources using Mode 2 resource selection. For example, the sidelink UEs may autonomously reserve the sidelink resources without input from a central entity, such as a network node. In some cases, the Mode 2 resource reservation may be based at least in part on transmitter-side sensing. In this case, each sidelink UE may decode SCI when the sidelink UE is not transmitting (or in a discontinuous reception (DRX) mode or a sensing disabled mode). The SCI that is received from the other sidelink UEs may indicate a current reservation and one or more future reservations. The future resources may be excluded from a set of candidate resources based at least in part on a priority level and/or an RSRP associated with the received SCI.

In some cases, to select the sidelink resources, a transmitter UE may determine a set of candidate resources by decoding (e.g., continuously decoding) SCI from one or more receiver UEs. The SCI may include reservation information, such as one or more resources (e.g., slots and/or resource blocks) that have been reserved by the one or more receiver UEs. If SCI is decoded from a receiver UE having a higher RSRP than the transmitter UE, such as due to interference caused by UE proximity, the transmitter UE may remove all resources indicated in the SCI from the set of candidate resources. The transmitter UE may select (e.g., randomly select) N resources from the set of candidate resources for transmitting a TB. In some cases, for every transmission of the TB, the transmitter UE may reserve one or more resources for one or more respective retransmissions of the TB. For example, the transmitter UE may reserve one or two additional slots for one or two respective retransmission of the TB. As shown by reference number 505, the transmitter UE may select resource 505 for an initial transmission of the TB. Additionally, the transmitter UE may select resource 510 and/or resource 515 for future retransmission(s) of the TB.

In some cases, sidelink resource allocation (e.g., in accordance with Release 16 of the 3GPP Standards) may result in an initial transmission of the TB being unprotected. In some cases, the initial transmission may collide with another transmission, such as a transmission by another sidelink UE that reserved the same resource. For example, using half-duplex communications, the intended receiver UE may transmit in the same slot that is used for the initial transmission of the TB. In some cases, the Mode 2 resource allocation may have link quality issues, such as due to non-line-of-sight (NLoS) transmissions or larger distances between the UEs, among other examples. This may lead to potential decoding failures of the SCI that carries the reservation information, which may result in collisions when the transmitter UE transmits using one of the previously reserved resources.

In some cases, reliability of the sidelink resource allocation (e.g., in accordance with Release 17 of the 3GPP Standards) may be enhanced by the sharing of sensing and/or reservation information between the UEs. In a first example, a sidelink UE may indicate future resources for other UEs to either transmit on (e.g., preferred resources) or exclude (e.g., non-preferred resources). This information (and/or other reservation information) may be transmitted using an SCI-2 format or a medium access control (MAC) control element (CE) (collectively, MAC-CE). The UEs receiving on the preferred resource may use only the resources in the preferred resource set for transmissions to the UE transmitting on the preferred resource set. The UEs receiving on the non-preferred resource set may exclude the resources from the non-preferred resource set from the set of candidate resources. In a second example, conflict indicators that indicate past or future conflicts may be shared among the sidelink UEs. The sidelink UEs that receive a conflict indicator may reselect resources for transmissions (or retransmissions) of the TB.

As indicated above, FIG. 5 is provided as an example. Other examples may differ from what is described with respect to FIG. 5.

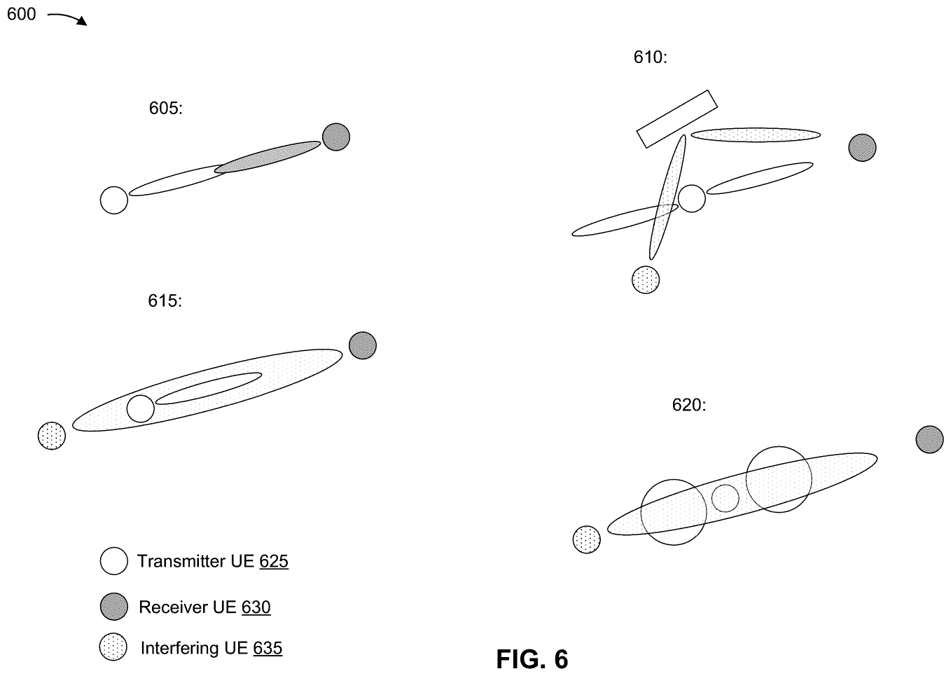

FIG. 6 is a diagram illustrating an example 600 of transmitter-side sensing and receiver-side sensing for sidelink communications, in accordance with the present disclosure.

In some cases, sidelink communications may occur within the mmWave spectrum. Communications in the mmWave spectrum may have higher path loss than communications in the sub-6 GHz range. In some cases, mmWave communications may require beamforming and/or spatial filtering in order to meet range requirements and/or QoS requirements. In some cases, considering hardware constraints, a sidelink UE may be able to beamform in one or more directions at a time. For a transmitter UE, this may imply that, for a selected beam, the TB being transmitted only reaches users in the angular range of the beam. Similarly, a beamformed receiver may only be able to receive from a narrow angular range (which may result in spatial blindness).

In some cases, transmitter-side resource allocation may be challenging for performing beamformed communications. For example, a sidelink UE may not know which direction an interfering or colliding transmission may come from. This may be especially problematic when there are multiple reflected paths from an interfering UE. In some cases, given the hardware limitations of the sidelink UE (e.g., with respect to analog beamforming), 360-degree sensing may require beam switching. For example, a sensing UE may not be able to detect a reservation when a receiver associated with the sensing UE is beamforming in a different direction than the direction from which the reservation is received. One solution may be broad-beam or omni-directional sensing for mmWave communications. However, the sensing may be limited as mmWave links may have high pathloss. This may lead to the receiver UE not being able to decode reservation information from transmitter UEs (e.g., far and medium range UEs) that are further than a threshold distance from the receiver UE.

Some examples of transmitter-side sensing and receiver-side sensing are shown by reference numbers 605, 610, 615, and 620. As shown by reference number 605, a transmitter UE 625 may communicate with a receiver UE 630. For example, the transmitter UE 625 and the receiver UE 630 may communicate using a transmitter-receiver beam pair link. In this example, the transmitter UE 625 may perform transmitter-side sensing using a transmitter-side sensing beam, and the receiver UE 630 may perform receiver-side sensing using a receiver-side sensing beam.

As shown by reference number 610, an interfering UE 635 may be located behind the transmitter UE 625 (with respect to the receiver UE 630). For example, the transmitter-side sensing beam may be pointed in a direction that is towards the receiver UE 630 but away from the interfering UE 635. In this case, the transmitter UE 625 may not be able to detect one or more reservations that are made by the interfering UE 625. As described herein, this may result in resource collisions, since both the transmitter UE 625 and the interfering UE 635 may reserve the same resource(s) for sidelink transmissions.

As shown by reference number 615, the transmitter UE 625 may have two transmitter-side sensing beams. A first transmitter-side sensing beam may be pointed towards the receiver UE 630 and a second transmitter-side sensing beam may be pointed in the opposite direction. The transmitter UE 625 may be equipped with enhanced hardware capability that includes the two sensing beams. However, as shown in the figure, the interfering UE 635 may not always be located directly behind the transmitter UE 625. For example, the interfering UE 635 may communicate with the receiver UE 630 by reflecting signals off an object. Thus, the transmitter UE 625 may not be able to detect colliding reservations that are made by the interfering UE 635 via the reflected paths.

As shown be reference number 620, the transmitter UE 625 may use wide beam sensing. Wide beam sensing may reduce spatial blindness, but may do so only over a limited range. With transmitter-side and receiver-side beamforming at the interfering UE 635 and the receiver UE 630, the interference may be considerable, even when wide beam or omni-directional sensing is unable to detect it.

Sidelink Mode 2 sensing (e.g., without input from a central entity) may be challenging for beamformed FR2 sidelink UEs. For example, sidelink UEs may only be able to form receiver beams in one direction or a limited number of directions at a time (e.g., due to hardware limitations of the UE for FR2). In some cases, a transmitter UE performing transmitter-side sensing may be unable to decode colliding reservations in SCI. For example, some communication paths may not be in a line of sight of the beam, and it may be difficult for the transmitter UE to sense all possible directions from which interfering signals may arrive. One possible solution is for the transmitter UE to perform wide beam or omni-directional sensing. However, this may reduce the range over which the signals are sensed. When the transmitter UE fails to detect or decode colliding reservations in the SCI, multiple transmissions may occur on the same resource, thereby resulting in reduced transmission reliability.

Techniques and apparatuses are described herein for sidelink resource allocation. In some aspects, a transmitter UE may transmit, and a receiver UE may receive, a request for sensing information that includes an indication of one or more transmit beam directions. The receiver UE perform a sensing operation associated with a select beam, of a plurality of beams configured for communications between the transmitter UE and the receiver UE, based at least in part on the indication of the one or more transmit beam directions. The receiver UE may transmit, and the transmitter UE may receive, an indication of the sensing information associated with the select beam. The transmitter UE may transmit one or more packets using one or more selected resources based at least in part on the sensing information associated with the select beam.

As described above, sidelink Mode 2 sensing may be challenging for beamformed FR2 sidelink UEs. A transmitter UE performing transmitter-side sensing may be unable to decode colliding reservations in SCI. For example, some communication paths may not be in a line of sight of the beam, and it may be difficult for the transmitter UE to sense all possible directions from which interfering signals may arrive. When the transmitter UE fails to detect or decode colliding reservations in the SCI, multiple transmissions may occur on the same resource, thereby resulting in reduced transmission reliability. Using the techniques and apparatuses described herein, the transmitter UE may transmit, to one or more receiver UEs, a request for sensing information that includes an indication of one or more transmit beam directions. A receiver UE, based at least in part on receiving the request, may perform sensing using a beam direction, such as a beam direction that is quasi co-located (QCL'd) with a candidate receiver beam, to identify one or more resource sets. The receiver UE may share the one or more resource sets with the transmitter UE, and the transmitter UE may combine the one or more resource sets with the transmitter-side resources or may transmit using only the receive-side sensing resources. This may reduce the likelihood of transmission collisions, therefore improving transmission reliability between the UEs. In particular, this may reduce the likelihood of transmission collisions and may improve the transmission reliability in mmWave sidelink communications, and may reduce power consumption by eliminating (or reducing) the need for continuous sensing. Additional details are described herein.

As indicated above, FIG. 6 is provided as an example. Other examples may differ from what is described with respect to FIG. 6.

FIG. 7 is a diagram illustrating an example 700 of sidelink resource allocation, in accordance with the present disclosure. A transmitter UE 705 may communicate with a receiver UE 710. The transmitter UE 705 and/or the receiver UE 710 may include some or all of the features of the UE 120, UE 305, UE 405, and/or UE 410. In some aspects, the transmitter UE 705 and the receiver UE 710 may communicate via a beam pair link. For example, the transmitter UE 705 and the receiver UE 710 may use a beamforming mechanism to establish the beam pair link. In some aspects, a connection between the transmitter UE 705 and the receiver UE 710 may be associated with an RRC context, such as a PC-5 RRC context.

As shown by reference number 715, the transmitter UE 705 may transmit, and the receiver UE 710 may receive, a request for sensing information that includes an indication of one or more transmit beam directions. The request for the sensing information may include an indication for the receiver UE 710 (or multiple receiver UEs 710) to perform sensing and share sensing information with the transmitter UE 705. The transmitter UE 705 may transmit the request for the sensing information based at least in part on receiving a packet from an upper layer device. In some aspects, the transmitter UE 705 may enable or disable transmitter-side sensing based at least in part on a configuration of the transmitter UE 705.

In some aspects, the request for the sensing information (e.g., the request to perform the sensing and share the sensing information) may include an indication of one or more transmit beam directions over which the transmission may take place. The one or more transmit beam directions may be indicated using a transmitter-side transmission configuration indicator (TCI) identifier, a transmitter beam-code, and/or a precoder index, among other examples. In some aspects, the request for the sensing information may include one or more transmit beam directions over which receiver-side sensing is to be performed. In some aspects, the request for the sensing information may include an indication of a time window over which resource information is requested. For example, the request may indicate a resource selection window (e.g., [T₁, T₂]) for a packet or a TB that is determined by latency or QoS requirements associated with the packet or the TB. In some aspects, the request for the sensing information may include an indication of traffic information. For example, the request may include an indication of a payload size, an estimated MCS, a periodicity, and/or a priority associated with a packet transmission, among other examples.

In some aspects, the transmitter UE 705 may transmit the request for the sensing information via an RRC message, SCI, or a MAC-CE (or a combination of the RRC message, SCI, and MAC-CE) over a sidelink shared channel. For example, the transmitter UE 705 may transmit an RRC message, SCI, or MAC-CE (or a combination of the RRC message, SCI, and MAC-CE) over the sidelink channel that includes an indication of the request for the sensing information. In this case, the transmitter UE 705 may transmit the request for the sensing information based at least in part on performing a random selection or limited transmitter-side sensing.

In some aspects, the transmitter UE 705 may transmit the request for the sensing information via an RRC message, SCI, or MAC-CE (or a combination of the RRC message, SCI, and MAC-CE) over a dedicated channel. For example, the transmitter UE 705 may transmit an RRC message, SCI, or MAC-CE (or a combination of the RRC message, SCI, and MAC-CE) over a configured (e.g., pre-configured) dedicated channel.

In some aspects, the transmitter UE 705 may transmit the request for the sensing information as a sequence over a dedicated channel, where the resource for the sequence transmission (e.g., time, frequency, and code) is generated based at least in part on an identifier associated with the transmitter UE 705, an identifier associated with the receiver UE 705, and/or a group identifier. In some aspects, a resource selection time window may be derived (e.g., implicitly derived) by the time at which the sequence is transmitted.

In some aspects, the transmitter UE 705 may transmit the request for the sensing information in accordance with one or more transmission occasions. In some aspects, the transmitter UE 705 may transmit the request for the sensing information each time the transmitter UE 705 is to transmit a transport block. In some aspects, the transmitter UE 705 may periodically transmit the request for the sensing information (e.g., in accordance with an interval) based at least in part on configuration information stored by the transmitter UE 705. In some aspects, the transmitter UE 705 may periodically transmit the request for the sensing information (e.g., in accordance with the interval or another interval) based at least in part on configuration information received via an RRC message. In some aspects, the request for the sensing information may be multiplexed with data (such as a TB transmission) and may be transmitted periodically or based at least in part on an event trigger.

As shown by reference number 720, the receiver UE 710 may perform a sensing operation associated with a select beam, of a plurality of beams configured for communications between the transmitter UE 705 and the receiver UE 710, based at least in part on the request for the sensing information. For example, the receiver UE 710 may perform the sensing operation based at least in part on the indication of the one or more transmit beam directions.

In some aspects, the request for the sensing information may not be multiplexed with other data (such as a TB transmission). In some aspects, the receiver UE 710 may determine that the receiver UE 710 can perform the sensing operation over the requested time window. For example, the receiver UE 710 may determine that the receiver UE 710 can perform the sensing operation over the requested time window based at least in part on one or more other active links associated with the receiver UE 710 and/or a transmission schedule associated with the receiver UE 710. The receiver UE 710 may transmit an acknowledgement message (e.g., ACK) to the transmitter UE 705 indicating that the receiver UE 710 can perform the sensing operation over the requested time window. In some aspects, the receiver UE 710 may determine that the receiver UE 710 cannot perform the sensing (e.g., within the requested time window). The receiver UE 710 may send a negative acknowledgement (e.g., NACK) to the transmitter UE 705 indicating that the receiver UE 710 cannot perform the sensing. Additionally, or alternatively, the receiver UE 710 may indicate one or more future occasions when the receiver UE 710 is able to perform the sensing and/or or may indicate a shift in the requested sensing window.

In some aspects, the request for the sensing information may be multiplexed with other data (such as the TB transmission). In some aspects, the receiver UE 710 may send an acknowledgement message (e.g., ACK) or a negative acknowledgement message (e.g., NACK) to the transmitter UE 705 based at least in part on decoding the data (e.g., based only on decoding the data). In some aspects, the receiver UE 710 may send an acknowledgement message or a negative acknowledgement message to the transmitter UE 705 based at least in part on the data being decoded and based at least in part on determining that the receiver UE 710 can perform the sensing. In some aspects, the receiver UE 710 may transmit feedback associated with the data and the request to perform the sensing on separate resources. For example, the receiver UE 710 may transmit first feedback to the transmitter UE 705 associated with decoding the data and may transmit second feedback to the transmitter UE 705 associated with the request to perform the sensing. The separate resources may be separate resource blocks or may be separate sequences, among other examples.

In some aspects, the receiver UE 710 may perform beam-based sensing based at least in part on setting a spatial filtering coefficient associated with the receiver UE 710 to a coefficient that is QCL'd with the potential receiver beam from the transmitter UE 705 or with a beam direction that is indicated in the request from the transmitter UE 705. In some aspects, the receiver UE 710 may perform beam-based sensing based at least in part on decoding sidelink reservations associated with an indicated direction for the time window indicated by the transmitter UE 705 in the request to perform the sensing. The time window may be an implicit time window or may be a configured (e.g. pre-configured) time window.

In some aspects, the receiver UE 710 may indicate a set of preferred and/or non-preferred resources to the transmitter UE 705. The set of preferred and/or non-preferred resources may be transmitted a certain time period (e.g., T_{process} seconds) after an end of the sensing window. In some aspects, the receiver UE 710 may transmit this information to the transmitter UE 705 as an RRC message, a MAC-CE, or SCI. For example, the receiver UE 710 may transmit an RRC message, a MAC-CE, or SCI, at the certain time period after the end of the sensing window, that includes an indication of the set of preferred and/or non-preferred resources.

As shown by reference number 725, the receiver UE 710 may transmit, and the transmitter UE 705 may receive, sensing information associated with the select beam. In some aspects, the transmitter UE 705 may receive sensing information from one or more receiver UEs 710 and may select one or more resources for transmission based at least in part on the sensing information.

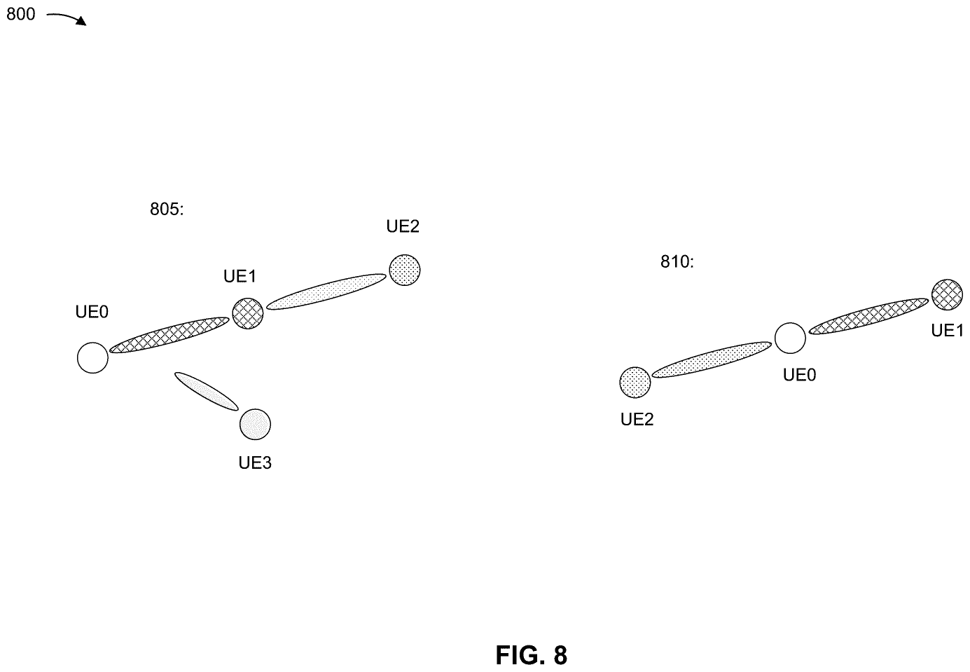

In some aspects, the transmitter UE 705 may combine the sensing information received from the one or more receiver UEs 710 and may select one or more resources for transmission based at least in part on the combined sensing information. In some aspects, the transmitter UE 705 may combine the resource information received from the one or more receiver UEs 710 associated with one or more transmit beam directions having a QCL and/or beam relationship, and may select one or more resources based at least in part on the combined sensing information. In some aspects, the transmitter UE 705 may combine the sensing information received from the one or more receiver UEs 710 with sensing information associated with the transmitter UE 705, and may select one or more resources based at least in part on the combined sensing information. The transmitter UE 705 may perform a transmission based at least in part on the selected resources. Additional details regarding these features are described in connection with FIG. 8.

In some aspects, the transmitter UE 705 may initiate a power saving mode based at least in part on the sensing information received from the receiver UE 710 and/or sensing information associated with the transmitter UE 705. Additionally, or alternatively, the receiver UE 710 may initiate a power saving mode based at least in part on the sensing information received from the transmitter UE 705 and/or sensing information associated with the receiver UE 710. In some aspects, the transmitter UE 705 or the receiver UE 710 may determine one or more sleep occasions (e.g., one or more DRX or discontinuous transmission (DTX) occasions) based at least in part on a transmission schedule and/or a sensing schedule. In some aspects, the transmitter UE 705 and/or the receiver UE 710 may share information (e.g., with the other of the transmitter UE 705 or the receiver UE 710) associated with the sleep or inactivity pattern. For example, the transmitter UE 705 and/or the receiver UE 710 may transmit an RRC message that includes an indication of the sleep or inactivity pattern.

As described above, sidelink Mode 2 sensing may be challenging for beamformed FR2 sidelink UEs. A transmitter UE performing transmitter-side sensing may be unable to decode colliding reservations in SCI. For example, some communication paths may not be in a line of sight of the beam, and it may be difficult for the transmitter UE to sense all possible directions from which interfering signals may arrive. When the transmitter UE fails to detect or decode colliding reservations in the SCI, multiple transmissions may occur on the same resource, thereby resulting in reduced transmission reliability. Using the techniques and apparatuses described herein, the transmitter UE 705 may transmit, to one or more receiver UEs 710, a request for sensing information that includes an indication of one or more transmit beam directions. The receiver UE 710, based at least in part on receiving the request, may perform sensing using a beam direction, such as a beam direction that is QCL'd with a candidate receiver beam, to identify one or more resource sets. The receiver UE 710 may share the one or more resource sets with the transmitter UE 705, and the transmitter UE 705 may combine the one or more resource sets with the transmitter-side resources or may transmit using only the receive-side sensing resources. Thus may reduce the likelihood of transmission collisions, therefore improving transmission reliability between the UEs. In particular, this may reduce the likelihood of transmission collisions and may improve the transmission reliability in mmWave sidelink communications, and may reduce power consumption by eliminating (or reducing) the need for continuous sensing.

As indicated above, FIG. 7 is provided as an example. Other examples may differ from what is described with respect to FIG. 7.

FIG. 8 is a diagram illustrating an example 800 of transmitter-side resource selection, in accordance with the present disclosure. In some aspects, a transmitter UE, such as the transmitter UE 705, may combine sensing information that is received from the one or more receiver UEs, such as the one or more receiver UEs 710, and may select one or more resources for transmission based at least in part on the combined sensing information. In some aspects, the transmitter UE 705 may combine resource information received from the one or more receiver UEs 710 associated with one or more transmit beam directions having a QCL and/or beam relationship (e.g., beam directions that are QCL'd with each other), and may select one or more resources based at least in part on the combined sensing information. In one example, as shown by reference number 805, a first UE (UE0) may combine resource information from one or more second UEs (such as UE1 and UE2) but may not combine resource information from one or more third UEs (such as UE3). In another example, as shown by reference number 810, the first UE (UE0) may combine resource information from UE1 and UE2 based at least in part on the resource information from UE1 and UE2 satisfying a beam relationship of being opposite to one another in terms of beam direction. In some aspects, the transmitter UE 705 may combine the sensing information received from the one or more receiver UEs 710 with sensing information associated with the transmitter UE 705, and may select one or more resources based at least in part on the combined sensing information. The transmitter UE 705 may perform a transmission based at least in part on the selected resources.

As indicated above, FIG. 8 is provided as an example. Other examples may differ from what is described with respect to FIG. 8.

FIG. 9 is a diagram illustrating an example process 900 performed, for example, by a transmitter UE, in accordance with the present disclosure. Example process 900 is an example where the UE (e.g., UE 120) performs operations associated with sidelink resource allocation.

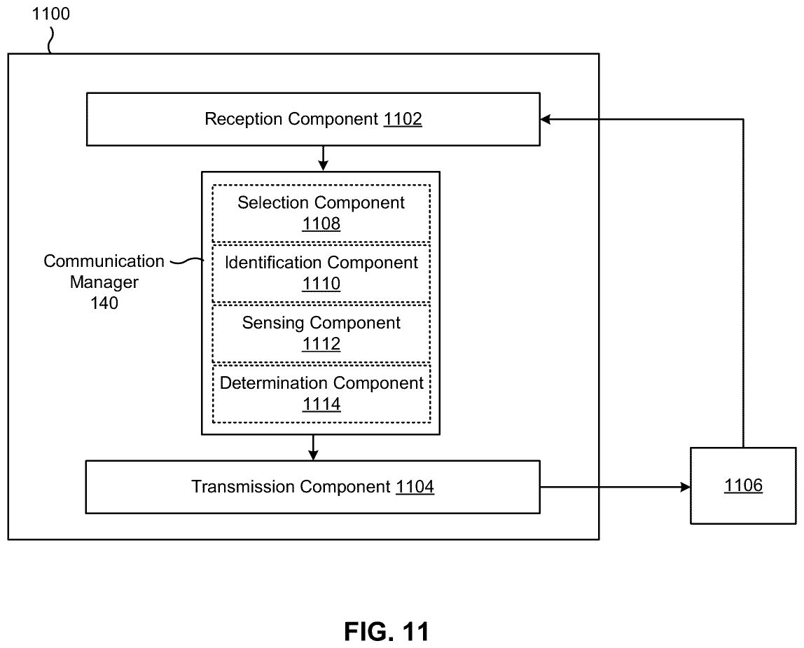

As shown in FIG. 9, in some aspects, process 900 may include transmitting, to a receiver UE, a request for sensing information that includes an indication of one or more transmit beam directions (block 910). For example, the UE (e.g., using communication manager 140 and/or transmission component 1104, depicted in FIG. 11) may transmit, to a receiver UE, a request for sensing information that includes an indication of one or more transmit beam directions, as described above.

As further shown in FIG. 9, in some aspects, process 900 may include receiving, from the receiver UE based at least in part on the indication of the one or more transmit beam directions, sensing information associated with a beam of a plurality of beams configured for communications between the transmitter UE and the receiver UE (block 920). For example, the UE (e.g., using communication manager 140 and/or reception component 1102, depicted in FIG. 11) may receive, from the receiver UE based at least in part on the indication of the one or more transmit beam directions, sensing information associated with a beam of a plurality of beams configured for communications between the transmitter UE and the receiver UE, as described above.

Process 900 may include additional aspects, such as any single aspect or any combination of aspects described below and/or in connection with one or more other processes described elsewhere herein.

In a first aspect, the request for the sensing information is a request for the receiver UE to perform sensing based at least in part on the one or more transmit beam directions and to transmit the sensing information to the transmitter UE.

In a second aspect, alone or in combination with the first aspect, the one or more transmit beam directions correspond to one or more transmit beam directions associated with a possible transmission by the transmitter UE.

In a third aspect, alone or in combination with one or more of the first and second aspects, the one or more transmit beam directions associated with the possible transmission by the transmitter UE are indicated by a transmission configuration information indicator, a beam codebook indicator, or a precoder index associated with the possible transmission by the transmitter UE.

In a fourth aspect, alone or in combination with one or more of the first through third aspects, the one or more transmit beam directions correspond to one or more transmit beam directions to be used by the receiver UE for performing a sensing operation.

In a fifth aspect, alone or in combination with one or more of the first through fourth aspects, process 900 includes transmitting an indication of a time window or a resource selection window during which resource information is to be received by the transmitter UE from the receiver UE.

In a sixth aspect, alone or in combination with one or more of the first through fifth aspects, process 900 includes transmitting traffic information that indicates at least one of a payload size, an estimated modulation coding scheme, a periodicity, or a priority associated with a transmission.

In a seventh aspect, alone or in combination with one or more of the first through sixth aspects, transmitting the request for the sensing information comprises transmitting a sidelink RRC message, SCI, or a sidelink MAC message, via a sidelink channel, that includes the request for the sensing information, transmitting the sidelink RRC message, the SCI, or the sidelink MAC message, via a dedicated channel for requesting sensing information, that includes the request for the sensing information, or transmitting the request for the sensing information as a sequence via the dedicated channel, wherein a resource associated with the sequence is based at least in part on a transmitter UE identifier, a receiver UE identifier, or a group identifier.

In an eighth aspect, alone or in combination with one or more of the first through seventh aspects, transmitting the request for the sensing information comprises transmitting the request for the sensing information in accordance with a transmission occasion, wherein transmitting the request for the sensing information in accordance with the transmission occasion comprises transmitting the request for the sensing information each time that a transport block is to be transmitted by the transmitter UE, or transmitting the request for the sensing information periodically based at least in part on a configured interval or an interval that is indicated by radio resource control information.

In a ninth aspect, alone or in combination with one or more of the first through eighth aspects, transmitting the request for the sensing information comprises transmitting a request for sensing information that is multiplexed with data.

In a tenth aspect, alone or in combination with one or more of the first through ninth aspects, process 900 includes receiving resource information from the receiver UE that indicates a plurality of resources for performing a transmission.

In an eleventh aspect, alone or in combination with one or more of the first through tenth aspects, process 900 includes selecting a resource from the plurality of resources, and performing a transmission of one or more packets via the selected resource.

In a twelfth aspect, alone or in combination with one or more of the first through eleventh aspects, selecting the resource from the plurality of resources comprises combining one or more transmitter UE resources with the plurality of resources to generate a combined resource set, and selecting the resource from the combined resource set.

In a thirteenth aspect, alone or in combination with one or more of the first through twelfth aspects, process 900 includes identifying a sleep occasion or a sleep cycle based at least in part on resource information that is received from the receiver UE.

In a fourteenth aspect, alone or in combination with one or more of the first through thirteenth aspects, process 900 includes transmitting an indication of the sleep occasion or the sleep cycle to the receiver UE.

In a fifteenth aspect, alone or in combination with one or more of the first through fourteenth aspects, the transmitter UE is configured to enable or disable sensing operations by the transmitter UE, and wherein transmitting the request for the sensing information comprises transmitting the request for the sensing information based at least in part on receiving a packet from an upper layer device.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a receiver UE, in accordance with the present disclosure. Example process 1000 is an example where the UE (e.g., UE 120) performs operations associated with sidelink resource allocation.

As shown in FIG. 10, in some aspects, process 1000 may include receiving, from a transmitter UE, a request for sensing information that includes an indication of one or more transmit beam directions (block 1010). For example, the UE (e.g., using communication manager 140 and/or reception component 1102, depicted in FIG. 11) may receive, from a transmitter UE, a request for sensing information that includes an indication of one or more transmit beam directions, as described above.

As further shown in FIG. 10, in some aspects, process 1000 may include performing a sensing operation associated with a select beam, of a plurality of beams configured for communications between the transmitter UE and the receiver UE, based at least in part on the indication of the one or more transmit beam directions (block 1020). For example, the UE (e.g., using communication manager 140 and/or sensing component 1112, depicted in FIG. 11) may perform a sensing operation associated with a select beam, of a plurality of beams configured for communications between the transmitter UE and the receiver UE, based at least in part on the indication of the one or more transmit beam directions, as described above.

As further shown in FIG. 10, in some aspects, process 1000 may include transmitting, to the transmitter UE, an indication of the sensing information associated with the select beam (block 1030). For example, the UE (e.g., using communication manager 140 and/or transmission component 1104, depicted in FIG. 11) may transmit, to the transmitter UE, an indication of the sensing information associated with the select beam, as described above.

Process 1000 may include additional aspects, such as any single aspect or any combination of aspects described below and/or in connection with one or more other processes described elsewhere herein.

In a first aspect, the request for the sensing information is not multiplexed with data.

In a second aspect, alone or in combination with the first aspect, process 1000 includes determining that the receiver UE is capable of performing the sensing operation during a time window based at least in part on scheduling information associated with the receiver UE.

In a third aspect, alone or in combination with one or more of the first and second aspects, process 1000 includes transmitting an acknowledgement message to the transmitter UE indicating that the receiver UE is to perform the sensing operation during the time window.

In a fourth aspect, alone or in combination with one or more of the first through third aspects, the request for the sensing information is multiplexed with data.

In a fifth aspect, alone or in combination with one or more of the first through fourth aspects, process 1000 includes transmitting an acknowledgement message to the transmitter UE based at least in part on decoding the data, transmitting an acknowledgement message to the transmitter UE based at least in part on decoding the data and determining that the receiver UE is to perform the sensing operation, or transmitting first feedback to the transmitter UE associated with the data via a first resource and transmitting second feedback to the transmitter UE associated with the request for the sensing information via a second resource.

In a sixth aspect, alone or in combination with one or more of the first through fifth aspects, performing the sensing operation associated with the select beam comprises sensing a channel using the select beam during a time window.

In a seventh aspect, alone or in combination with one or more of the first through sixth aspects, sensing the channel using the select beam comprises setting a spatial filtering coefficient to a spatial filtering coefficient that is quasi co-located with a beam that is indicated in the request from the transmitter UE, and performing the sensing operation for the one or more transmit beam directions during the time window.

In an eighth aspect, alone or in combination with one or more of the first through seventh aspects, process 1000 includes transmitting an indication of a preferred resource or a non-preferred resource to the transmitter UE.

In a ninth aspect, alone or in combination with one or more of the first through eighth aspects, transmitting the indication of the preferred resource or the non-preferred resource to the transmitter UE comprises transmitting the indication of the preferred resource or the non-preferred resource to the transmitter UE at a time after an end of a sensing window.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 140. The communication manager 140 may include one or more of a selection component 1108, an identification component 1110, a sensing component 1112, or a determination component 1114, among other examples.

In some aspects, the apparatus 1100 may be configured to perform one or more operations described herein in connection with FIGS. 708. Additionally, or alternatively, the apparatus 1100 may be configured to perform one or more processes described herein, such as process 900 of FIG. 9, process 1000 of FIG. 10, or a combination thereof. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The transmission component 1104 may transmit, to a receiver UE, a request for sensing information that includes an indication of one or more transmit beam directions. The reception component 1102 may receive, from the receiver UE based at least in part on the indication of the one or more transmit beam directions, sensing information associated with a beam of a plurality of beams configured for communications between the transmitter UE and the receiver UE.

The transmission component 1104 may transmit an indication of a time window or a resource selection window during which resource information is to be received by the transmitter UE from the receiver UE. The transmission component 1104 may transmit traffic information that indicates at least one of a payload size, an estimated modulation coding scheme, a periodicity, or a priority associated with a transmission.

The reception component 1102 may receive resource information from the receiver UE that indicates a plurality of resources for performing a transmission. The selection component 1108 may select a resource from the plurality of resources, and performing a transmission of one or more packets via the selected resource. The identification component 1110 may identify a sleep occasion or a sleep cycle based at least in part on resource information that is received from the receiver UE. The transmission component 1104 may transmit an indication of the sleep occasion or the sleep cycle to the receiver UE.

The reception component 1102 may receive, from a transmitter UE, a request for sensing information that includes an indication of one or more transmit beam directions. The sensing component 1112 may perform a sensing operation associated with a select beam, of a plurality of beams configured for communications between the transmitter UE and the receiver UE, based at least in part on the indication of the one or more transmit beam directions. The transmission component 1104 may transmit, to the transmitter UE, an indication of the sensing information associated with the select beam. The determination component 1114 may determine that the receiver UE is capable of performing the sensing operation during a time window based at least in part on scheduling information associated with the receiver UE. The transmission component 1104 may transmit an acknowledgement message to the transmitter UE indicating that the receiver UE is to perform the sensing operation during the time window.

The transmission component 1104 may transmit an acknowledgement message to the transmitter UE based at least in part on decoding the data, transmitting an acknowledgement message to the transmitter UE based at least in part on decoding the data and determining that the receiver UE is to perform the sensing operation, or transmitting first feedback to the transmitter UE associated with the data via a first resource and transmitting second feedback to the transmitter UE associated with the request for the sensing information via a second resource. The transmission component 1104 may transmit an indication of a preferred resource or a non-preferred resource to the transmitter UE.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a transmitter user equipment (UE), comprising: transmitting, to a receiver UE, a request for sensing information that includes an indication of one or more transmit beam directions; and receiving, from the receiver UE based at least in part on the indication of the one or more transmit beam directions, sensing information associated with a beam of a plurality of beams configured for communications between the transmitter UE and the receiver UE.

Aspect 2: The method of Aspect 1, wherein the request for the sensing information is a request for the receiver UE to perform sensing based at least in part on the one or more transmit beam directions and to transmit the sensing information to the transmitter UE.

Aspect 3: The method of any of Aspects 1-2, wherein the one or more transmit beam directions correspond to one or more transmit beam directions associated with a possible transmission by the transmitter UE.

Aspect 4: The method of Aspect 3, wherein the one or more transmit beam directions associated with the possible transmission by the transmitter UE are indicated by a transmission configuration information indicator, a beam codebook indicator, or a precoder index associated with the possible transmission by the transmitter UE.

Aspect 5: The method of any of Aspects 1-4, wherein the one or more transmit beam directions correspond to one or more transmit beam directions to be used by the receiver UE for performing a sensing operation.

Aspect 6: The method of any of Aspects 1-5, further comprising transmitting an indication of a time window or a resource selection window during which resource information is to be received by the transmitter UE from the receiver UE.

Aspect 7: The method of any of Aspects 1-6, further comprising transmitting traffic information that indicates at least one of a payload size, an estimated modulation coding scheme, a periodicity, or a priority associated with a transmission.

Aspect 8: The method of any of Aspects 1-7, wherein transmitting the request for the sensing information comprises: transmitting a sidelink radio resource control (RRC) message, sidelink control information (SCI), or a sidelink medium access control (MAC) message, via a sidelink channel, that includes the request for the sensing information; transmitting the sidelink RRC message, the SCI, or the sidelink MAC message, via a dedicated channel for requesting sensing information, that includes the request for the sensing information; or transmitting the request for the sensing information as a sequence via the dedicated channel, wherein a resource associated with the sequence is based at least in part on a transmitter UE identifier, a receiver UE identifier, or a group identifier.

Aspect 9: The method of any of Aspects 1-8, wherein transmitting the request for the sensing information comprises transmitting the request for the sensing information in accordance with a transmission occasion, wherein transmitting the request for the sensing information in accordance with the transmission occasion comprises: transmitting the request for the sensing information each time that a transport block is to be transmitted by the transmitter UE; or transmitting the request for the sensing information periodically based at least in part on a configured interval or an interval that is indicated by radio resource control information.

Aspect 10: The method of any of Aspects 1-9, wherein transmitting the request for the sensing information comprises transmitting a request for sensing information that is multiplexed with data.

Aspect 11: The method of any of Aspects 1-10, further comprising receiving resource information from the receiver UE that indicates a plurality of resources for performing a transmission.

Aspect 12: The method of Aspect 11, further comprising selecting a resource from the plurality of resources, and performing a transmission of one or more packets via the selected resource.

Aspect 13: The method of Aspect 12, wherein selecting the resource from the plurality of resources comprises combining one or more transmitter UE resources with the plurality of resources to generate a combined resource set, and selecting the resource from the combined resource set.

Aspect 14: The method of any of Aspects 1-13, further comprising identifying a sleep occasion or a sleep cycle based at least in part on resource information that is received from the receiver UE.

Aspect 15: The method of Aspect 14, further comprising transmitting an indication of the sleep occasion or the sleep cycle to the receiver UE.

Aspect 16: The method of any of Aspects 1-15, wherein the transmitter UE is configured to enable or disable sensing operations by the transmitter UE, and wherein transmitting the request for the sensing information comprises transmitting the request for the sensing information based at least in part on receiving a packet from an upper layer device.

Aspect 17: A method of wireless communication performed by a receiver user equipment (UE), comprising: receiving, from a transmitter UE, a request for sensing information that includes an indication of one or more transmit beam directions; performing a sensing operation associated with a select beam, of a plurality of beams configured for communications between the transmitter UE and the receiver UE, based at least in part on the indication of the one or more transmit beam directions; and transmitting, to the transmitter UE, an indication of the sensing information associated with the select beam.

Aspect 18: The method of Aspect 17, wherein the request for the sensing information is not multiplexed with data.

Aspect 19: The method of Aspect 18, further comprising determining that the receiver UE is capable of performing the sensing operation during a time window based at least in part on scheduling information associated with the receiver UE.

Aspect 20: The method of Aspect 19, further comprising transmitting an acknowledgement message to the transmitter UE indicating that the receiver UE is to perform the sensing operation during the time window.

Aspect 21: The method of any of Aspects 17-20, wherein the request for the sensing information is multiplexed with data.

Aspect 22: The method of Aspect 21, further comprising transmitting an acknowledgement message to the transmitter UE based at least in part on decoding the data, transmitting an acknowledgement message to the transmitter UE based at least in part on decoding the data and determining that the receiver UE is to perform the sensing operation, or transmitting first feedback to the transmitter UE associated with the data via a first resource and transmitting second feedback to the transmitter UE associated with the request for the sensing information via a second resource.

Aspect 23: The method of any of Aspects 17-22, wherein performing the sensing operation associated with the select beam comprises sensing a channel using the select beam during a time window.

Aspect 24: The method of Aspect 23, wherein sensing the channel using the select beam comprises setting a spatial filtering coefficient to a spatial filtering coefficient that is quasi co-located with a candidate receiver beam and to perform the sensing operation for the one or more transmit beam directions during the time window.

Aspect 25: The method of any of Aspects 17-24, further comprising transmitting an indication of a preferred resource or a non-preferred resource to the transmitter UE.

Aspect 26: The method of Aspect 25, wherein transmitting the indication of the preferred resource or the non-preferred resource to the transmitter UE comprises transmitting the indication of the preferred resource or the non-preferred resource to the transmitter UE at a time after an end of a sensing window.

Aspect 27: An apparatus for wireless communication at a device, comprising a processor; memory coupled with the processor; and instructions stored in the memory and executable by the processor to cause the apparatus to perform the method of one or more of Aspects 1-16.

Aspect 28: A device for wireless communication, comprising a memory and one or more processors coupled to the memory, the one or more processors configured to perform the method of one or more of Aspects 1-16.

Aspect 29: An apparatus for wireless communication, comprising at least one means for performing the method of one or more of Aspects 1-16.

Aspect 30: A non-transitory computer-readable medium storing code for wireless communication, the code comprising instructions executable by a processor to perform the method of one or more of Aspects 1-16.

Aspect 31: A non-transitory computer-readable medium storing a set of instructions for wireless communication, the set of instructions comprising one or more instructions that, when executed by one or more processors of a device, cause the device to perform the method of one or more of Aspects 1-16.

Aspect 32: An apparatus for wireless communication at a device, comprising a processor; memory coupled with the processor; and instructions stored in the memory and executable by the processor to cause the apparatus to perform the method of one or more of Aspects 17-26.

Aspect 33: A device for wireless communication, comprising a memory and one or more processors coupled to the memory, the one or more processors configured to perform the method of one or more of Aspects 17-26.

Aspect 34: An apparatus for wireless communication, comprising at least one means for performing the method of one or more of Aspects 17-26.

Aspect 35: A non-transitory computer-readable medium storing code for wireless communication, the code comprising instructions executable by a processor to perform the method of one or more of Aspects 17-26.

Aspect 36: A non-transitory computer-readable medium storing a set of instructions for wireless communication, the set of instructions comprising one or more instructions that, when executed by one or more processors of a device, cause the device to perform the method of one or more of Aspects 17-26.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a transmitter user equipment (UE), comprising:
a memory; and
one or more processors, coupled to the memory, configured to:
transmit, to a receiver UE, a request for sensing information that includes an indication of one or more transmit beam directions; and
receive, from the receiver UE based at least in part on the indication of the one or more transmit beam directions, sensing information associated with a beam of a plurality of beams configured for communications between the transmitter UE and the receiver UE.

2. The apparatus of claim 1, wherein the request for the sensing information is a request for the receiver UE to perform sensing based at least in part on the one or more transmit beam directions and to transmit the sensing information to the transmitter UE.

3. The apparatus of claim 1, wherein the one or more transmit beam directions correspond to one or more transmit beam directions associated with a possible transmission by the transmitter UE.

4. The apparatus of claim 3, wherein the one or more transmit beam directions associated with the possible transmission by the transmitter UE are indicated by a transmission configuration information indicator, a beam codebook indicator, or a precoder index associated with the possible transmission by the transmitter UE.

5. The apparatus of claim 1, wherein the one or more transmit beam directions correspond to one or more transmit beam directions to be used by the receiver UE for performing a sensing operation.

6. The apparatus of claim 1, wherein the one or more processors are further configured to transmit an indication of a time window or a resource selection window during which resource information is to be received by the transmitter UE from the receiver UE.

7. The apparatus of claim 1, wherein the one or more processors are further configured to transmit traffic information that indicates at least one of a payload size, an estimated modulation coding scheme, a periodicity, or a priority associated with a transmission.

8. The apparatus of claim 1, wherein the one or more processors, to transmit the request for the sensing information, are configured to:
transmit a sidelink radio resource control (RRC) message, sidelink control information (SCI), or a sidelink medium access control (MAC) message, via a sidelink channel, that includes the request for the sensing information;
transmit the sidelink RRC message, the SCI, or the sidelink MAC message, via a dedicated channel for requesting sensing information, that includes the request for the sensing information; or
transmit the request for the sensing information as a sequence via the dedicated channel, wherein a resource associated with the sequence is based at least in part on a transmitter UE identifier, a receiver UE identifier, or a group identifier.

9. The apparatus of claim 1, wherein the one or more processors, to transmit the request for the sensing information, are configured to transmit the request for the sensing information in accordance with a transmission occasion, and wherein the one or more processors, to transmit the request for the sensing information in accordance with the transmission occasion, are configured to:
transmit the request for the sensing information each time that a transport block is to be transmitted by the transmitter UE; or
transmit the request for the sensing information periodically based at least in part on a configured interval or an interval that is indicated by radio resource control information.

10. The apparatus of claim 1, wherein the one or more processors, to transmit the request for the sensing information, are configured to transmit a request for sensing information that is multiplexed with data.

11. The apparatus of claim 1, wherein the one or more processors are further configured to receive resource information from the receiver UE that indicates a plurality of resources for performing a transmission.

12. The apparatus of claim 11, wherein the one or more processors are further configured to select a resource from the plurality of resources, and perform a transmission of one or more packets via the selected resource.

13. The apparatus of claim 12, wherein the one or more processors, to select the resource from the plurality of resources, are configured to combine one or more transmitter UE resources with the plurality of resources to generate a combined resource set, and select the resource from the combined resource set.

14. The apparatus of claim 1, wherein the one or more processors are further configured to identify a sleep occasion or a sleep cycle based at least in part on resource information that is received from the receiver UE.

15. The apparatus of claim 14, wherein the one or more processors are further configured to transmit an indication of the sleep occasion or the sleep cycle to the receiver UE.

16. The apparatus of claim 1, wherein the transmitter UE is configured to enable or disable sensing operations by the transmitter UE, and wherein transmitting the request for the sensing information comprises transmitting the request for the sensing information based at least in part on receiving a packet from an upper layer device.

17. An apparatus for wireless communication at a receiver user equipment (UE), comprising:
a memory; and
one or more processors, coupled to the memory, configured to:
receive, from a transmitter UE, a request for sensing information that includes an indication of one or more transmit beam directions;
perform a sensing operation associated with a select beam, of a plurality of beams configured for communications between the transmitter UE and the receiver UE, based at least in part on the indication of the one or more transmit beam directions; and
transmit, to the transmitter UE, an indication of the sensing information associated with the select beam.

18. The apparatus of claim 17, wherein the request for the sensing information is not multiplexed with data.

19. The apparatus of claim 18, wherein the one or more processors are further configured to determine that the receiver UE is capable of performing the sensing operation during a time window based at least in part on scheduling information associated with the receiver UE.

20. The apparatus of claim 19, wherein the one or more processors are further configured to transmit an acknowledgement message to the transmitter UE indicating that the receiver UE is to perform the sensing operation during the time window.

21. The apparatus of claim 17, wherein the request for the sensing information is multiplexed with data.

22. The apparatus of claim 21, wherein the one or more processors are further configured to transmit an acknowledgement message to the transmitter UE based at least in part on decoding the data, transmit an acknowledgement message to the transmitter UE based at least in part on decoding the data and determining that the receiver UE is to perform the sensing operation, or transmit first feedback to the transmitter UE associated with the data via a first resource and transmitting second feedback to the transmitter UE associated with the request for the sensing information via a second resource.

23. The apparatus of claim 17, wherein the one or more processors, to perform the sensing operation associated with the select beam, are configured to sense a channel using the select beam during a time window.

24. The apparatus of claim 23, wherein the one or more processors, to sense the channel using the select beam, are configured to set a spatial filtering coefficient to a spatial filtering coefficient that is quasi co-located with a candidate receiver beam and to perform the sensing operation for the one or more transmit beam directions during the time window.

25. The apparatus of claim 17, wherein the one or more processors are further configured to transmit an indication of a preferred resource or a non-preferred resource to the transmitter UE.

26. The apparatus of claim 25, wherein the one or more processors, to transmit the indication of the preferred resource or the non-preferred resource to the transmitter UE, are configured to transmit the indication of the preferred resource or the non-preferred resource to the transmitter UE at a time after an end of a sensing window.

27. A method of wireless communication performed by a transmitter user equipment (UE), comprising:
transmitting, to a receiver UE, a request for sensing information that includes an indication of one or more transmit beam directions; and
receiving, from the receiver UE based at least in part on the indication of the one or more transmit beam directions, sensing information associated with a beam of a plurality of beams configured for communications between the transmitter UE and the receiver UE.

28. The method of claim 27, wherein the one or more transmit beam directions correspond to one or more transmit beam directions associated with a possible transmission by the transmitter UE or one or more transmit beam directions to be used by the receiver UE for performing a sensing operation.

29. A method of wireless communication performed by a receiver user equipment (UE), comprising:
receiving, from a transmitter UE, a request for sensing information that includes an indication of one or more transmit beam directions;
performing a sensing operation associated with a select beam, of a plurality of beams configured for communications between the transmitter UE and the receiver UE, based at least in part on the indication of the one or more transmit beam directions; and
transmitting, to the transmitter UE, an indication of the sensing information associated with the select beam.

30. The method of claim 29, further comprising transmitting an acknowledgement message to the transmitter UE indicating that the receiver UE is to perform the sensing operation during a time window.
